(19) United States
(12) Patent Application Publication
(10) Pub. No.: US 2012/0281148 A1
(43) Pub. Date: Nov. 8, 2012

(54) LIGHTING DEVICE, DISPLAY DEVICE AND TELEVISION RECEIVER

(75) Inventor: Takahiro Yoshikawa, Osaka-shi (JP)

(73) Assignee: SHARP KABUSHIKI KAISHA, Osaka-shi, Osaka (JP)

(21) Appl. No.: 13/520,620

(22) PCT Filed: Dec. 17, 2010
(86) PCT No.: PCT/JP2010/072761

§ 371 Date: Jul. 5, 2012

(30) Foreign Application Priority Data
Jan. 13, 2010 (JP) 2010-005166

(51) Int. Cl. H04N 5/44; G02F 1/13357; F21V 13/02; F21V 8/00; F21V 29/00

(52) U.S. Cl. 348/725; 362/613; 362/609; 349/65; 348/E05.096

(57) ABSTRACT

In a backlight unit, expansion of a light guide plate and thermal deformation of a light source board may occur. It is an object of the present invention to maintain optical design of the backlight unit with absorbing the expansion of the light guide plate. The backlight unit 24 includes a LED board 30, at least one LED 28 mounted on the LED board 30, a light guide plate 20 having a light entrance surface 20a facing the LED 28, a backlight chassis 22, a spacer member 25 arranged on the LED board 30, and an elastic member 19 arranged between the LED board 30 and the backlight chassis 22. The backlight chassis 22 houses the LED board 30, the LED 28, and the light guide plate 20. The spacer member 25 is configured to restrict a distance W1 between the LED board 30 and the light guide plate 20. The elastic member 19 has Young's modulus smaller than the spacer member 25.

### TECHNICAL FIELD

The present invention relates to a lighting device, a display device and a television receiver.

### BACKGROUND ART

In recent years, a display element of an image display device such as a television receiver is shifting from a conventional CRT display device to a thin display device using a thin display element such as a liquid crystal panel and a plasma display panel. This enables the image display device to have a reduced thickness. A liquid crystal panel used for a liquid crystal display device does not emit light, and thus a backlight unit is required as a separate lighting device.

Patent Document 1 discloses a backlight unit including a light guide plate, a light source, a light source mount, and an elastic member. The light guide plate has a side surface that serves as a light entrance surface. The light source is arranged to face the light entrance surface of the light guide plate and is mounted on the light source mount. The light source mount is arranged such that a part thereof is positioned between the light source and the light guide plate. The elastic member is arranged to be in contact with the light source mount. In such a backlight unit, if the light guide plate expands toward the light source, a distance between the light source and the light guide plate is restricted by the light source mount. Thus, the distance is maintained within a specific range. In addition, the expansion of the light guide plate is absorbed by the elastic member via the light source mount.
Patent Document 1: Japanese Unexamined Patent Publication No. 2002-203418

### Problem to be Solved by the Invention

In order to unitize a plurality of light sources as a unit, a light source board on which the light sources are mounted may be employed in some cases. If the backlight unit described in the above Patent Document 1 employs the light source board on which the light sources are mounted, the position of a surface of the light source board may not be restricted. Specifically, the light source board may be thermally deformed if heat is generated around the light source board due to the emission of light from the light source. This results in warping and lifting up of the light source board. The warping and lifting up of the light source board cause a large change in a distance between the light source and the light guide plate. Thus, the optical design of the backlight unit cannot be maintained.

### DISCLOSURE OF THE PRESENT INVENTION

The present invention was accomplished in view of the above circumstances. It is an object of the present invention to provide a technology that can maintain the optical design of an edge-light type backlight unit including a light source and a light source board on which the light source is mounted. Even if the expansion of the light guide plate and the thermal deformation of the light source board occur, the technology maintains the optical design with absorbing the expansion of the light guide plate. It is another object of the present invention to provide a display device including the lighting device and a television receiver including the display device.

### Means for Solving the Problem

To solve the above problem, a lighting device includes a light source board, at least one light source arranged on a surface of the light source board, a light guide plate having a side surface serving as a light entrance surface, a chassis, a spacer member arranged on the surface of the light source board, and an elastic member arranged between the light source board and the chassis. The light entrance surface faces the at least one light source. The chassis is configured to house the light source board, the at least one light source, and the light guide plate. The spacer member is configured to restrict a distance between the light source board and the light guide plate. The elastic member has Young's modulus smaller than the spacer member.

In the lighting device described herein, the elastic member has Young's modulus smaller than the spacer member. Thus, if the light guide plate expands toward the light source, the expansion of the light guide plate is not absorbed by the spacer member, but absorbed by the elastic member. The expansion of the light guide plate can be absorbed with the distance between the light source board and the light guide plate being restricted by the spacer member. In addition, the spacer member is arranged on the light source board. Thus, even if the light source board is thermally deformed, the warping and lifting up of the light source board can be restricted by the spacer member. Accordingly, if the expansion of the light guide plate and the thermal deformation of the light source board occur, the optical design of the above lighting device can be maintained with the expansion of the light guide plate being absorbed.

In the above lighting device, the elastic member may be in contact with the light source board. With this configuration, if the light guide plate expands toward the light source, the expansion of the light guide plate is directly absorbed by the elastic member via the spacer member and the light source board. Thus, the expansion of the light guide plate is effectively absorbed.

In the above lighting device, the elastic member may have heat release properties. With this configuration, heat generated around the light source can be effectively released outside the lighting device through the elastic member. Accordingly, the heat is less likely to be conducted to the light guide plate, resulting in the reduction in the thermal expansion of the light guide plate and the thermal deformation of the light source board.

In the above lighting device, the elastic member may be made of silicone resin. Compared with the elastic member made of non-silicone resin such as an acrylic resin, the elastic member made of silicone resin is excellent in heat resistance, flame retardancy, and the like. This improves the properties of the elastic member.

In the above lighting device, the elastic member may have adhesion properties. With this configuration, the elastic member can be directly fixed to the light source board and the chassis without using an adhesion tape or the like.

In the above lighting device, the spacer member may have a shape tapered toward the light guide plate. In such a case, a tip end portion of the spacer member may have a curvature. Some of the rays of light that enters the light guide plate from the light source may be blocked by the spacer member. Thus, when the spacer member is in contact with the light guide plate, a dark portion may be formed in the light guide plate. In this configuration, since the spacer member is tapered toward the light guide plate, the contact area of the spacer member and the light guide plate is small. This reduces the range (area) of the dark portion that may be formed in the light guide plate, so that the optical design of the lighting device can be maintained with high accuracy. In addition, when the tip end portion of such a spacer member has a curvature, the damage of the light entrance surface of the light guide plate and the damage and the cutoff of the tip end portion of the spacer member are less likely to occur at the time of contact between the spacer member and the light guide plate.

In the above lighting device, the at least one light source may include a plurality of light sources. The light sources may be arranged linearly on the light source board, and the spacer member may be arranged between the adjacent light sources. When the light sources are arranged linearly on the surface of the light source board, a dark portion may be formed on a part of a side surface of the light guide plate that faces a part of a surface of the light source board that is located between the adjacent light sources. According to the above configuration, the contact area of the spacer member and the light guide plate is reduced. Thus, the range (area) of the dark portion to be formed in the light guide plate is reduced, so that the optical design of the lighting device can be maintained with high accuracy.

The above lighting device may further include a reflector. The light entrance surface may have an elongated shape. The reflector may be arranged in a vicinity of an area between the at least one light source and the light guide plate so as to extend along a long-side direction of the light entrance surface. With this configuration, the light that is scattered outside the light guide plate can enter the light guide plate by the reflector. Thus, the light entrance efficiency of the light entering the light guide plate from the light source can be improved.

The technology disclosed herein may be embodied as a display device including a display panel configured to display by using light provided by the above lighting device. Further, a display device including a liquid crystal panel using liquid crystals as the display panel has novelty and utility. Furthermore, a television receiver including the above display device has novelty and utility. The above display device and television can have an increased display area.

### Advantageous Effect of the Invention

According to the technology disclosed herein, in the edge-light type backlight unit including the light source board on which the light source is arranged, the expansion of the light guide plate can be absorbed even if the light guide plate is expanded and the light source board is thermally deformed. Thus, the optical design of the backlight unit can be maintained.

### BRIEF DESCRIPTION OF THE DRAWINGS

FIG. 1 is an exploded perspective view illustrating a television receiver TV according to the first embodiment of the present invention;

FIG. 2 is an exploded perspective view of a liquid crystal display device 10;

FIG. 3 is a cross-sectional view of the liquid crystal display device 10;

FIG. 4 is a plan view schematically illustrating a backlight unit 24;

FIG. 5 is an exploded perspective view illustrating a liquid crystal display device 110 according to the second embodiment; and

FIG. 6 is a cross-sectional view of the liquid crystal display device 110.

### MODE FOR CARRYING OUT THE INVENTION

### First Embodiment

Embodiments of the present invention will be described with reference to the drawings. Note that each of the drawings has a part showing an X-axis, a Y-axis, and a Z-axis. The axes in each drawing correspond to the respective axes in other drawings. The Y-axis direction and the X-axis direction, respectively, correspond to the vertical direction and the horizontal direction. The description of upper and lower side is based on the vertical direction unless otherwise specified.

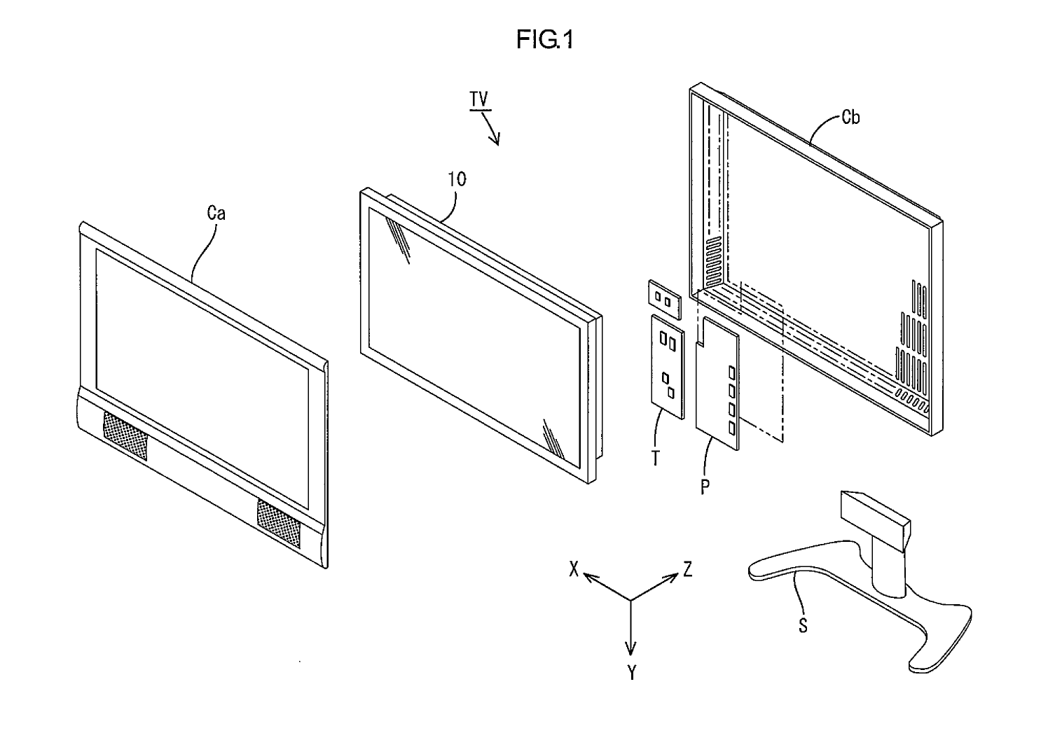

FIG. 1 illustrates a television receiver TV according to the present embodiment in an exploded perspective view. As illustrated in FIG. 1, the television receiver TV includes a liquid crystal display device 10, front and back cabinets Ca and Cb, a power supply P, a tuner T, and a stand S. The front and back cabinets Ca and Cb sandwich, and thus house, the liquid crystal display device 10.

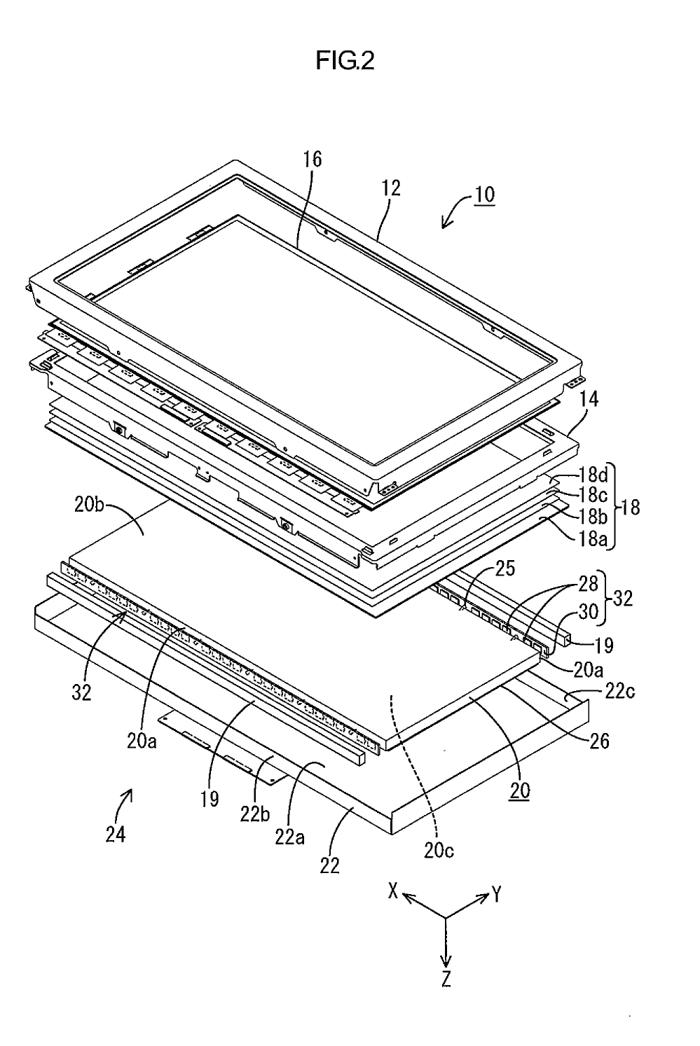

FIG. 2 illustrates the liquid crystal display device 10 in an exploded perspective view. Herein, an upper side in FIG. 2 corresponds to a front side, and a lower side therein corresponds to a rear side. As illustrated in FIG. 2, the liquid crystal display device 10 has a landscape quadrangular shape as a whole. The liquid crystal display device 10 includes a liquid crystal panel 16 as a display panel, and a backlight unit 24 as an external light source. The liquid crystal panel 16 and the backlight unit 24 are integrally held by a frame-shaped bezel 12 and the like.

Next, the liquid crystal panel 16 will be explained. The liquid crystal panel 16 is configured such that a pair of transparent (high light transmissive) glass substrates is bonded together with a predetermined gap therebetween and a liquid crystal layer (not illustrated) is sealed between the glass substrates. On one of the glass substrates, switching components (for example, TFTs) connected to source lines and gate lines which are perpendicular to each other, pixel electrodes connected to the switching components, an alignment film, and the like are provided. On the other glass substrate, color filters having color sections such as red (R), green (G), and blue (B) color sections arranged in a predetermined pattern, counter electrode, an alignment film, and the like are provided. Image data and control signals that are necessary to display an image are sent to the source lines, the gate lines, and the counter electrodes, from a drive circuit substrate, which is not illustrated. Polarizing plates (not illustrated) are arranged on outer surfaces of the glass substrates.

Next, the backlight unit 24 will be explained. As illustrated in FIG. 2, the backlight unit 24 includes a backlight chassis 22, an optical member 18, and a frame 14. The backlight chassis 22 has a substantially box-like shape with an opening on the front side (a light exit side, the liquid crystal panel 16 side). The optical member 18 is provided on the front surface (the light exit surface) of the light guide plate 20. The frame 14 has a frame shape and supports the liquid crystal panel 16 along an inner edge thereof. The backlight chassis 22 houses a pair of elastic members 19, 19, a pair of LED (Light Emitting Diode) units 32, 32, and a light guide plate 20. Each of the elastic members 19, 19 has a rectangular cross-sectional shape extending along the long-side direction of the backlight chassis 22. The pair of elastic members 19, 19 is arranged on the respective long-side outer edges of the backlight chassis 22. The pair of LED units 32 is each arranged on an inner surface of the respective elastic member 19 with the LED light sources 28 and the spacer members 25 being mounted on the LED board 30. The LED units 32 are configured to emit light. The light guide plate 20 is arranged between the pair of LED units 32, 32 and configured to guide the light emitted from the LED unit 32 toward the liquid crystal panel 16. The optical member 18 is provided on a front surface of the light guide plate 20. The backlight unit 24 of the present embodiment is an edge-light type (side-light type) backlight unit in which the light guide plate 20 and the optical member 18 are arranged right behind the liquid crystal panel 16, and the LED units 32 as light sources are arranged on a side end portion of the light guide plate 20.

The backlight chassis 22 is made of metal such as an aluminum material. The backlight chassis 22 includes a bottom plate 22a having a rectangular shape in a plan view, and side plates 22b, 22c each of which rises from an outer edge of the corresponding long or short sides of the bottom plate 22a toward the front side. The long side of the bottom plate 22a matches a horizontal direction (X-axis direction) and the short side thereof matches a vertical direction (Y-axis direction). The light guide plate 20 is housed in a space between the pair of LED units 32, 32 in the backlight chassis 22. On a rear surface of the bottom plate 22a, a power circuit board that supplies power to the LED unit 32 is attached, for example.

The optical member 18 includes, a diffuser plate 18a, a diffuser sheet 18b, a lens sheet 18c, and a reflection-type polarizing plate 18d arranged in this sequence from the light guide plate 20 side. The diffuser sheet 18b, the lens sheet 18c, and the reflection-type polarizing plate 18d are configured to convert the light that passed through the diffuser plate 18a into planar light. The liquid crystal panel 16 is provided on the front side of the reflection-type polarizing plate 18d. The optical member 18 is provided between the light guide plate 20 and the liquid crystal panel 16.

The LED unit 32 includes the LED board 30, the LED light sources 28, and the spacer members 25. The LED board 30 is made of resin and has a rectangular shape. The LED light sources 28 each emit white light. The LED light sources 28 and the spacer members 25 are arranged along a line on the LED board 30. The spacer members 25 are arranged at equal intervals and positioned between the LED light sources 28. The spacer member 25 will be explained in detail later with reference to another drawing. The pair of LED units 32, 32 is each fixed to the side surface of the elastic member 19 by bonding, for example, such that the LED light sources 28 and the spacer members 25 included in one of the LED units 32, 32 face those included in the other one of the LED units 32, 32.

The light guide plate 20 is a plate member having a rectangular shape. The light guide plate 20 is made of resin such as acrylic that has a high light transmission (high transparency). As illustrated in FIG. 2, the light guide plate 20 is arranged between the opposing LED units 32 such that a main surface (a light exit surface) 20b thereof faces the diffuser plate 18a. A reflection sheet 26 is provided on a surface of the light guide plate 20 that is opposite from the surface facing the diffuser plate 18a. The reflection sheet 26 reflects the light that leaks from the light guide plate 20, so that the leaked light enters the light guide plate 20 again. With this light guide plate 20, the light from the LED unit 32 enters the light guide plate 20 through the side surface (light entrance surface) and exits through the main surface facing the diffuser plate 18a. Thus, the liquid crystal panel 16 is irradiated with the light from the rear side thereof.

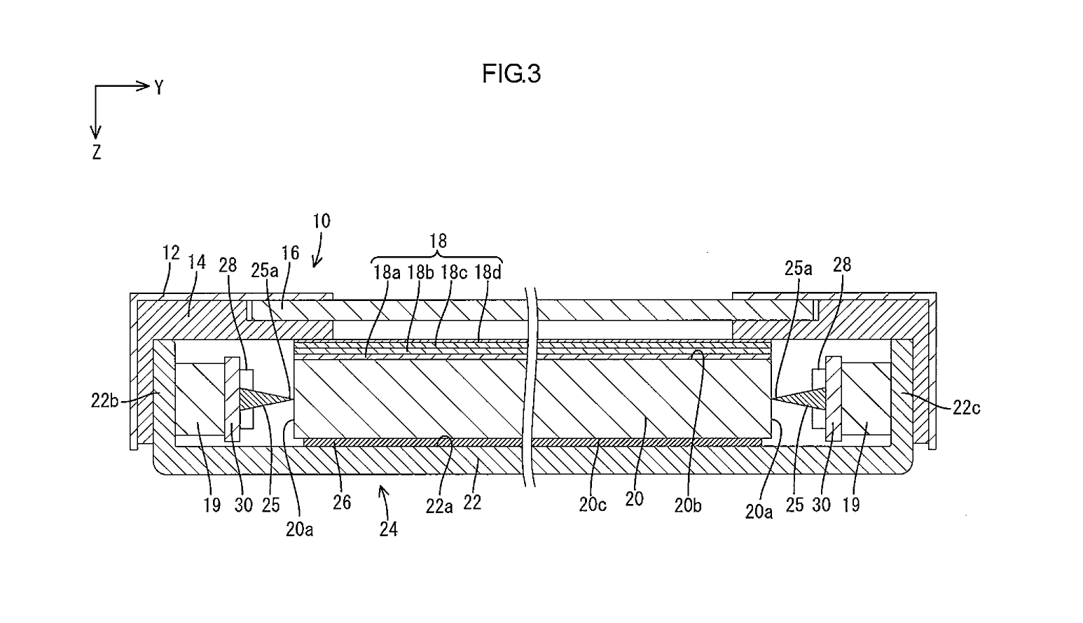

FIG. 3 illustrates the liquid crystal display device 10 in a cross-sectional view. The cross-sectional view in FIG. 3 illustrates a sectional configuration of the liquid crystal display device 10 taken along a Y-Z plane passing through the spacer member 25. As illustrated in FIG. 3, the spacer member 25 is arranged between the LED board 30 and the light guide plate 20. The spacer member 25 has a shape tapered toward the light guide plate 20. The tip end portion 25a of the spacer member 25 has a curvature and is in contact with the light entrance surface 20a of the light guide plate 20. The spacer member 25 is fixed to the surface of the LED board 30 by bonding.

As illustrated in FIG. 3, the elastic member 19 is arranged between the LED board 30 and the backlight chassis 22 so as to be in contact with both of them. The surfaces of the elastic member 19 that are in contact with the LED board 30 and the backlight chassis 22 each have adhesion properties. The elastic member 19 is fixed to the LED board 30 and the backlight chassis 22 by bonding the surfaces thereof to the LED board 30 and the backlight chassis 22. The elastic member 19 is made of silicone resin, and thus has heat release properties. The elastic member 19 has Young's modulus smaller than the spacer member 25.

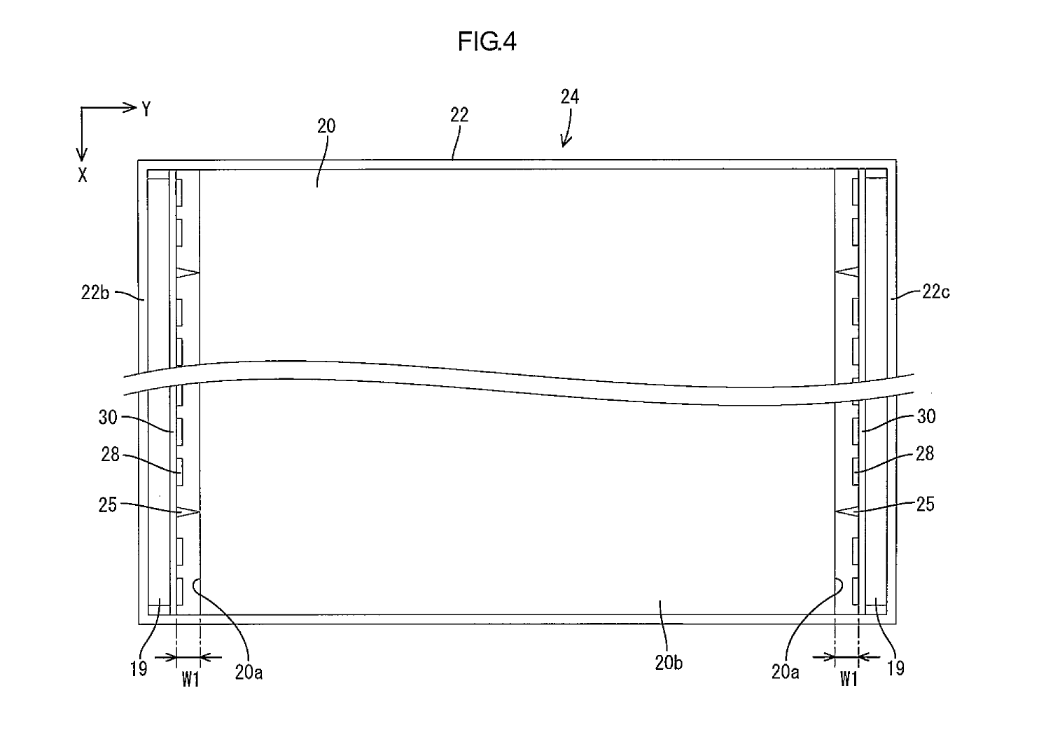

FIG. 4 illustrates the backlight unit 24 in a schematic plan view. As illustrated in FIG. 4, the distance W1 between the LED board 30 and the light guide plate 20 is restricted by the spacer member 25, so that the distance W1 between the LED light source 28 and the light guide plate 20 is kept constant. If the light guide plate 20 expands toward the LED light source 28, the LED board 30 displaces in the vertical direction to compress the elastic member 19 with the distance W1 between the LED board 30 and the light guide plate 20 kept constant. Thus, the expansion of the light guide plate 20 is absorbed by the elastic member 19.

The television receiver TV of the present embodiment is described above. According to the backlight unit 24 of the television receiver TV of the present embodiment, the elastic member 19 has Young's modulus smaller than the spacer member 25. Thus, if the light guide plate 20 expands toward the LED light source 28, the expansion of the light guide plate 20 is not absorbed by the spacer member 25, but absorbed by the elastic member 19. With this configuration, the expansion of the light guide plate 20 can be absorbed with the distance W1 between the LED board 30 and the light guide plate 20 being restricted by the spacer member 25. In addition, since the spacer member 25 is provided on the surface of the LED board 30, the warping or lifting up of the LED board 30 can be restricted by the spacer member if the LED board 30 is thermally deformed. As described above, in the backlight unit 24, even if the expansion of the light guide plate 20 or the thermal deformation of the LED board 30 occurs, the optical design of the backlight unit 24 can be maintained with the expansion of the light guide plate 20 being absorbed.

In the above embodiment, the elastic member 19 is in contact with the LED board 30. Thus, if the light guide plate 20 expands toward the LED light source 28, the expansion of the light guide plate 20 is directly absorbed by the elastic member 19 via the spacer member 25 and the LED board 30. Accordingly, the expansion of the light guide plate 20 can be effectively absorbed.

In the above embodiment, the elastic member 19 has heat release properties. Thus, the heat generated around the LED light source 28 can be effectively released outside the backlight unit 24 through the elastic member 19. Accordingly, the amount of heat conducted to the light guide plate 20 can be reduced. As a result, the thermal expansion of the light guide plate 20 and the thermal deformation of the LED board 30 are less likely to occur.

In the above embodiment, the elastic member 19 is made of silicone resin. Compared with the elastic member made of acrylic resin, the elastic member 19 of the above embodiment is excellent in heat resistance and flame retardancy.

In the above embodiment, the surfaces of the elastic member 19 that contact the LED board 30 and the backlight chassis 22 have adhesion properties. Accordingly, the elastic member 19 can be directly fixed to the LED board 30 and the backlight chassis 22 without using an adhesive tape, for example.

In the above embodiment, the spacer member 25 has a shape tapered toward the light guide plate 20. This reduces the range (area) of the dark portion that may be formed on the light guide plate 20. Accordingly, the optical design of the backlight unit 24 can be maintained with high accuracy. Further, the tip end portion 25a of the spacer member 25 has a curvature.

Accordingly, the damage of the light entrance surface 20a of the light guide plate 20 and the damage and the cutoff of the tip end portion 25a of the spacer member 25 are less likely to occur.

### Second Embodiment

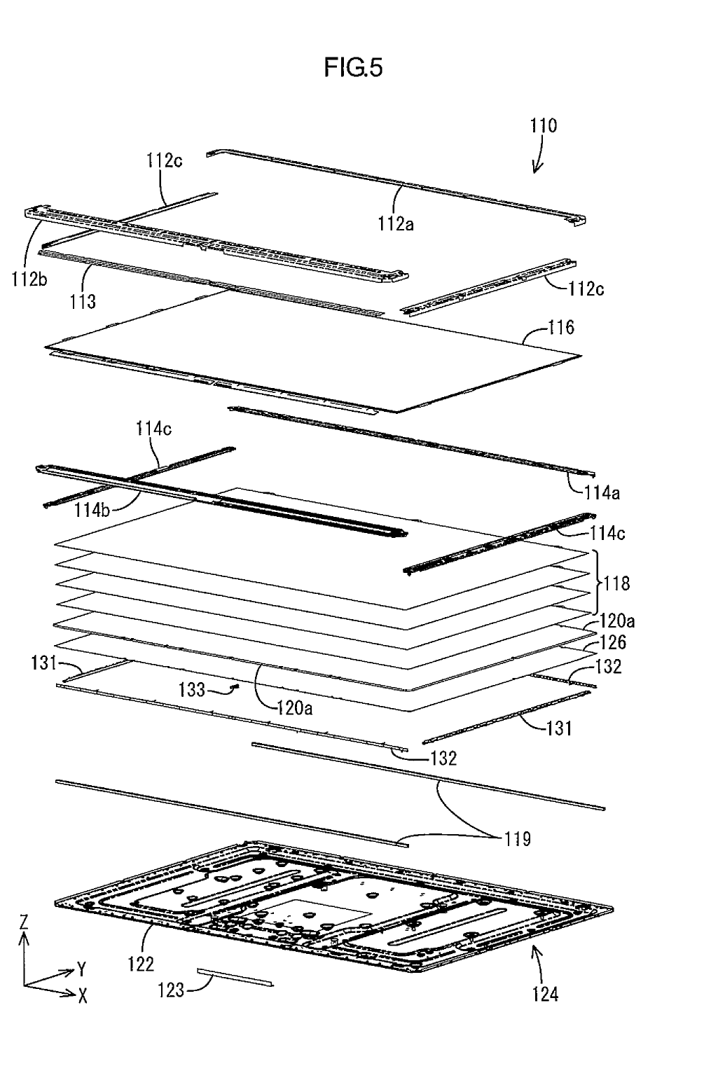

FIG. 5 shows a liquid crystal display device 110 according to the second embodiment in an exploded perspective view. An upper side in FIG. 5 corresponds to the front side, and a lower side therein corresponds to the rear side. As illustrated in FIG. 5, the liquid crystal display device 110 has a landscape quadrangular shape as a whole. The liquid crystal display device 110 includes a liquid crystal panel 116 as a display panel and a backlight unit 124 as an external light source. The liquid crystal panel 116 and the backlight unit 124 are integrally held by a top bezel 112a, a bottom bezel 112b, and a side bezel 112c (hereinafter, referred to as a bezel set 112a to 112c), for example. Since the liquid crystal panel 116 has the same configuration as the liquid crystal panel 16 in the first embodiment, the configuration thereof will not be explained.

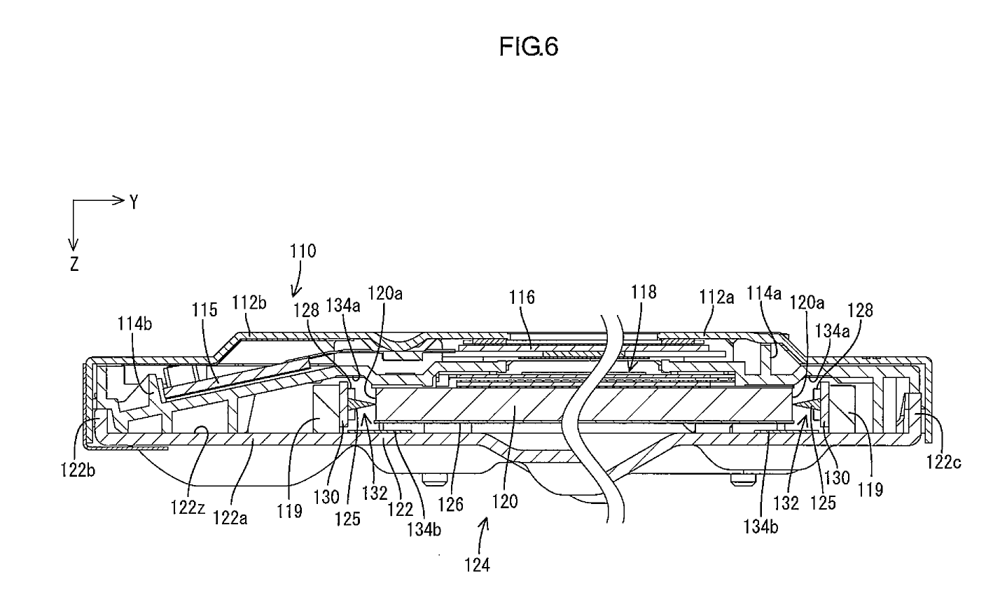

The backlight unit 124 will be explained below. As illustrated in FIG. 5, the backlight unit 124 includes a backlight chassis 122, an optical member 118, a top frame 114a, a bottom frame 114b, side frames 114c (hereinafter, referred to as a frame set 114a to 114c), and a reflection sheet 126. The liquid crystal panel 116 is sandwiched between the bezel set 112a to 112c and the frame set 114a to 114c. The reference symbol 113 indicates an insulation sheet. The insulation sheet 113 insulates the drive circuit board 115 (see, FIG. 6) configured to drive the liquid crystal panel. The backlight chassis 122 has a substantially box-like shape having a bottom and an opening on the front side (the light exit surface side, the liquid crystal panel 116 side). The optical member 118 is provided on the front surface of the light guide plate 120. The reflection sheet 126 is provided on the rear surface of the light guide plate 120. The backlight chassis 122 houses a pair of cable holders 131, a pair of elastic members 119, 119, a pair of LED units 132, 132, and a light guide plate 120. The pair of elastic members 119, 119 extends along the long-side direction of the backlight chassis 122. The pair of LED units 132, 132 extends along the long-side direction of the backlight chassis 122 and on which the spacer members 125 are mounted (see FIG. 6). The LED unit 132, the light guide plate 120, and the reflection sheet 126 are supported each other by a rubber bush 133. On a rear surface of the backlight chassis 122, a power circuit board (not illustrated) that supplies power to the LED unit 132, a protective cover 123 configured to protect the power circuit board, and the like are provided. The pair of cable holders 131, 131 extends along the short-side direction of the backlight chassis. The pair of cable holders 131, 131 houses wires that electrically connect the LED unit 132 and the power circuit board.

FIG. 6 illustrates the backlight unit 124 in a cross-sectional view. The cross-sectional view in FIG. 6 illustrates a cross-sectional configuration of the liquid crystal display device 110 taken along a Y-Z plane passing through the spacer member 125. As illustrated in FIG. 6, the backlight chassis 122 includes a bottom plate 122a having a bottom surface 122z and side plates 122b, 122c rising a little from the outer edge of the bottom plate 122a. The backlight chassis 122 at least supports the elastic member 119, the LED unit 132, and the light guide plate 120. The light guide plate 120 is arranged between the pair of LED units 132, 132. The light guide plate 120 and the optical member 118 are sandwiched between the frame set 114a to 114c and the backlight chassis 122. Since the light guide plate 120 and the optical member 118 have the same configuration as those described in the first embodiment, the configuration thereof will not be explained.

The pair of elastic members 119, 119 each has a rectangular cross-section. The pair of elastic members 119, 119 is arranged along the respective long side of the backlight chassis 122. A bottom surface of the elastic member 119 is fixed to the bottom plate 122a of the backlight chassis 122. Each of the pair of LED units 132, 132 is fixed on the side surface of the respective elastic members 119 such that the light exit surfaces thereof face each other. Accordingly, the pair of LED units 132, 132 is each supported by the bottom plate 122a of the backlight chassis 122 via the elastic member 119. Further, the elastic member 119 has heat release properties, and thus the heat generated on the LED unit 132 is released outside the backlight unit 124 through the bottom plate 122a of the backlight chassis 122. Since the spacer member 125 and the LED unit 132 have the same configuration as those described in the first embodiment, the configuration thereof will not be explained.

As illustrated in FIG. 6, the drive circuit board 115 is provided on a front surface of the bottom frame 114b. The drive circuit board 115 is electrically connected to the display panel 116 and is configured to supply image data and various control signals necessary to display the image to the liquid crystal panel 116. Further, reflectors 134a are each provided on a portion of a surface of the top frame 114a and the bottom frame 114b exposed to the corresponding LED units 132. The reflectors 134a each extend along the long-side direction of the light entrance surface 120a of the light guide plate 120. In addition, reflectors 134b are each provided on a portion of a surface of the backlight chassis 122 facing the corresponding LED unit 132. The reflectors 134b each extend along the long-side direction of the light entrance surface 120a of the light guide plate 120.

In the backlight unit 124 of the present embodiment, the reflectors 134a are each provided on the surface of the top frame 114a and the bottom frame 114b. In addition, the reflectors 134b are each provided on the surface of the backlight chassis 122. This effectively improves the light entrance efficiency of the light entering the light guide plate 120 from the LED unit 132.

The configuration of the embodiments correspond to the configuration of the present invention as follows: the LED light source 28 is one example of “light source”; the LED board 30, 130 is one example of “light source board”; the backlight chassis 22, 122 is one example of “chassis”; the backlight unit 24, 124 is one example of “lighting device”; and the liquid crystal display device 10, 110 is one example of “display device”.

The above embodiments may include the following modifications.

(1) In the above embodiments, the LED light source that emits white light is mounted. However, LED light sources of three different colors, namely, red, green and blue, may be mounted on a surface. Alternatively, blue LED light sources and a yellow phosphor may be used in combination.

(2) In the above embodiments, the LED sources are arranged on the two opposing side-surface sides of the light guide plate. However, the LED sources may be arranged on three or all (four) side-surface sides of the light guide plate.

(3) In the above embodiments, the spacer member is provided as a separate member from the LED board. However, the spacer member may be integrally formed with the LED board.

(4) The arrangement, configuration, mounting method of the spacer member are not limited to those described in the above embodiments, and may be suitably changed.

(5) In the above embodiment, the elastic member is made of silicone resin, but not limited to the silicone resin.

(6) The arrangement, configuration, mounting method of the elastic member are not limited to those described in the above embodiments, and may be suitably changed.

(7) In the above embodiments, the liquid crystal display device including the liquid crystal panel as a display panel is used. The technology can be applied to display devices including other types of display panels.

(8) In the above embodiments, the television receiver including the tuner is used. However, the technology can be applied to a display device without a tuner.

The embodiments of the present invention are explained in detail above for illustrative propose only, and it is to be understood that the claims are not limited by the forgoing description. The technology described in the claims includes the various modifications of the embodiments described above.

The technology components described in the description and the drawings are not required to be used in the combination described in the claims as originally filed. The technology components can show its technical utility when used either alone or in combination. In addition, the technology described in the above description and the drawings can achieve more than one object at the same time, and the technical utility of the technology can be recognized when the technology achieves one of the objects.

### EXPLANATION OF SYMBOLS

TV: television receiver, Ca, Cb: cabinet, T: tuner, S: stand, 10, 110: liquid crystal display device, 12: bezel, 14: frame, 16, 116: liquid crystal panel, 18, 118: optical member, 18a: diffuser plate, 18b: diffuser sheet, 18c: lens sheet, 18d: reflection-type polarizing plate, 19, 119: elastic member, 20, 120: light guide plate, 20a, 120a: light entrance surface, 20b: light exit surface, 20c: surface opposite to the light exit surface, 22, 122: backlight chassis, 22a, 122a: bottom plate, 24, 124: backlight unit, 25, 125: spacer member, 25a: tip end portion (of spacer member), 26, 126: reflection sheet, 28: LED light source, 30, 130: LED board, 32, 132: LED unit, 112a: top bezel, 112b: bottom bezel, 112c: side bezel, 113: insulating sheet, 114a: top frame, 114b: bottom frame, 114c: side frame, 115: drive circuit board, 123: protective cover, 131: cable holder, 134a, 134b: reflector

1. A lighting device comprising:
a light source board;
at least one light source arranged on a surface of the light source board;
a light guide plate having a side surface serving as a light entrance surface, the light entrance surface facing the at least one light source;
a chassis configured to house the light source board, the at least one light source, and the light guide plate;
a spacer member arranged on the surface of the light source board, the spacer member being configured to restrict a distance between the light source board and the light guide plate; and
an elastic member arranged between the light source board and the chassis, the elastic member having Young's modulus smaller than the spacer member.

2. The lighting device according to claim 1, wherein the elastic member is in contact with the light source board.

3. The lighting device according to claim 1, wherein the elastic member has heat release properties.

4. The lighting device according to claim 1, wherein the elastic member is made of silicone resin.

5. The lighting device according to claim 1, wherein the elastic member has adhesion properties.

6. The lighting device according to claim 1, wherein the spacer member has a shape tapered toward the light guide plate.

7. The lighting device according to claim 6, wherein the spacer member has a tip end portion that has a curvature.

8. The lighting device according to claim 1, wherein:
the at least one light source comprises a plurality of light sources, the light sources being arranged linearly on the light source board; and
the spacer member is arranged between the adjacent light sources.

9. The lighting device according to claim 1, further comprising a reflector,
wherein the light entrance surface has an elongated shape, and the reflector is arranged in a vicinity of an area between the at least one light source and the light guide plate so as to extend along a long-side direction of the light entrance surface.

10. A display device comprising:
a display panel configured to provide display using light from the lighting device according to claim 1.

11. The display device according to claim 10, wherein the display panel is a liquid crystal panel using liquid crystals.

12. A television receiver comprising the display device according to claim 10.
